(19) United States
(12) Patent Application Publication
(10) Pub. No.: US 2009/0059380 A1
(43) Pub. Date: Mar. 5, 2009

(54) Optical Imager for Producing an Optical Display

(76) Inventors: Renaud Moliton, Charenton-le-Pont (FR); Cecile Bonafos, Paris (FR)

Correspondence Address: SOFER & HAROUN LLP., 317 MADISON AVENUE, SUITE 910, NEW YORK, NY, 10017, US

(21) Appl. No.: 11/884,243

(22) PCT Filed: Mar. 2, 2006
(86) PCT No.: PCT/FR2006/050188

§ 371 Date: Sep. 15, 2008

(30) Foreign Application Priority Data
Mar. 10, 2005 (FR) 0550627

(51) Int. Cl. G02B 27/01

(52) U.S. Cl. 359/630

(57) ABSTRACT

The invention relates to an optical imager including a waveguide having a front face and a rear face and into which light beams emitted by an optical element of a light-beam generator system are introduced via an inlet surface and are directed towards the eye of the wearer through said rear face by means of an optical arrangement, so as to make it possible to view information content, said front and rear faces of the waveguide presenting a property of angular selectivity in reflectance and transmittance, and said optical arrangement comprising a Mangin mirror and a quarterwave plate between said front face and said mirror. In the invention, said quarterwave plate is encapsulated between said mirror and another element.

The present invention relates to an optical imager for producing an optical display and for making it possible to project information of the image or multimedia type. In particular, it can be positioned on an eyeglass frame.

### BACKGROUND OF THE INVENTION

Such an information display makes it possible to view multimedia content coming from a mobile telephone, an MP4 or DVD player, a personal computer, a game console, or any other device that enables multimedia content to be supplied.

It is known from U.S. Pat. No. 6,204,974 to make such an imager. Such an optical imager is for shaping the light beams coming from an electronic and optical light-beam generator system of the miniature screen, laser diode, or light-emitting diode type, for generating light beams from an electronic signal. The optical imager directs the light beams towards the eye of the wearer so as to make it possible to view the information content.

That known optical imager is made up of a waveguide having a front face and a rear face and into which light beams emitted by an optical element of a light-beam generator system are introduced via an inlet surface and are directed towards the eye of the wearer, so as to make it possible to view information content by means of a mirror having an angle of reflection of 45° and by means of a lens carried by said rear face.

Because the light beams propagate parallel to the plane of the lens and are reflected at 45°, and because of the way the lens is arranged, such an imager presents thickness that is relatively large, if the apparent size desired for the projected image is to be sufficiently large and acceptable. This is prejudicial to obtaining a compact display system.

U.S. Pat. No. 6,222,677 discloses an optical imager including a waveguide having a front face and a rear face and into which light beams emitted by an optical element of a light-beam generator system are introduced via an inlet surface and are directed towards the eye of the wearer through said rear face by means of an optical arrangement, so as to make it possible to view information content, said front and rear faces of the waveguide presenting a property of angular selectivity in reflectance and transmittance, and said optical arrangement comprising a Mangin mirror and a quarterwave plate between said front face and said mirror.

A spherical Mangin mirror is a lens having one of its faces made reflective by treating it with aluminum or the like.

By means of such an imager, it is possible to obtain an information display that is removable, small, and light. However, problems arise in putting the quarterwave plate into place, since it is very difficult to ensure that it is plane.

### OBJECTS AND SUMMARY OF THE INVENTION

The invention resolves that problem, while continuing to provide an information display that is removable, small, and light. The weight of the imager is thus minimized, and since the imager is situated close to an eyeglass lens, it does not risk unbalancing the frame.

To do this, the invention proposes an optical imager including a waveguide having a front face and a rear face and into which light beams emitted by an optical element of a light-beam generator system are introduced via an inlet surface and are directed towards the eye of the wearer through said rear face by means of an optical arrangement, so as to make it possible to view information content, said front and rear faces of the waveguide presenting a property of angular selectivity in reflectance and transmittance, and said optical arrangement comprising a Mangin mirror and a quarterwave plate between said front face and said mirror, wherein said quarterwave plate is encapsulated between said mirror and another element.

The term “angular selectivity in reflectance and transmittance” is used to mean that a face presents high reflectance for light in a certain range of angles of incidence, typically ±10° centered about 60°, and, simultaneously, high transmittance about an angle of incidence that is normal to within ±10°.

The thickness of an imager of the invention can be about 4 millimeters (mm).

The use of a system with a Mangin mirror makes it possible to reduce the weight of the optical elements and makes it possible to compensate the chromatic aberration of the optical system.

The invention makes it possible to position power close to the eye so as to minimize optical aberrations and vignetting, and to minimize the associated components of the display, thereby making it possible to reduce its overall volume and its overall weight.

The invention also makes it possible to obtain a waveguide that is transparent, thereby ensuring that the wearer has a good view of the surroundings.

In a first preferred embodiment of the invention, said other element is a lens, said optical arrangement including a film of air between said front face and said lens.

In a second preferred embodiment of the invention, said other element is an optical isolator treatment carried by said front face.

Preferably, said isolator treatment is carried by a backing plate.

Advantageously, said inlet surface is inclined, the first reflection of the light beams taking place on said front face.

This configuration is particularly compatible with the size of the wearer's head.

Preferably, said optical element presents an emission surface that is parallel to said inlet surface.

Preferably, the material of said Mangin mirror is different from the material of said waveguide.

Preferably, said optical arrangement includes an inclined polarization-separator treatment for reflecting the light beams towards said mirror and for transmitting the light beams coming from said mirror.

Advantageously, said optical arrangement includes a backing prism on which said polarization-separator treatment is deposited.

### BRIEF DESCRIPTION OF THE DRAWINGS

The invention is described in greater detail below with reference to the figures which show a preferred embodiment only of the invention.

FIG. 1 is a plan view of an imager of the invention, constituting a first variant embodiment.

FIG. 2 is a plan view of an imager of the invention, constituting a second variant embodiment.

FIG. 3 is a plan view of an imager of the invention, constituting another embodiment of the second variant embodiment.

FIG. 4 is a perspective view of a waveguide of the invention.

FIG. 5 is a perspective view of a mechanical support device forming part of the waveguide.

### MORE DETAILED DESCRIPTION

Identical elements have the same references in the figures.

An optical imager of the invention includes a waveguide 1 having a front face 1A and a rear face 1B and into which light beams emitted by an optical element of a light-beam generator system are introduced via an inlet surface 1C and are directed towards the eye O of the wearer through the rear face 1B by means of an optical arrangement, so as to make it possible to view information content.

In this embodiment, the front and rear faces 1A and 1B of the waveguide are used in reflection, and a miniature screen 2 constituting the optical element of the light-beam generator system and emitting the light beams towards the imager is disposed in such a manner that the light beams are reflected a plurality of times between the reflective front and rear faces 1A and 1B between said beams being introduced into and leaving the imager.

The faces are used either with total internal reflection or with reflection that is assisted by a special multi-layer treatment that provides high reflectance of the light about the selected angle of incidence, while being transparent for normal incidence.

Optionally, the waveguide can include an anti-reflection treatment.

The waveguide 1 is made of transparent material that does not impede viewing the surroundings.

The material of the waveguide is preferably a high-index material in order to obtain the greatest possible angular range for total internal reflection, so as to be able to provide display devices that present the widest possible field of vision, i.e. an image of the greatest possible apparent size. Such a material generally has a low Abbe number. By way of example, the waveguide 1 can be constituted by a flint glass, e.g. SF5.

Very advantageously, the inlet surface 1C is inclined, the first reflection of the light beams taking place on the front face 1A. The inclination of the inlet face 1C and the first reflection on the front face 1A enable the miniature screen to be disposed so that it extends the inlet surface 1C thereby conforming to the shape of the wearer's face, light beams being emitted substantially perpendicularly to the emission plane of said screen, which plane is itself substantially parallel to the inlet surface 1C. In other words, the light-beam generator system with its miniature screen is not disposed in alignment with the imager as a whole, where it would be bulky and unattractive.

The optical arrangement directing the light beams towards the eye O of the wearer through the rear face 1B comprises a plano-convex spherical Mangin mirror 3, and a quarterwave plate 4 that is disposed between the front face 1A and the mirror 3 and that is bonded to the plane face of the mirror.

It should be observed that the Mangin mirror is not necessarily of plano-convex spherical shape, but could also present faces that are aspherical in shape.

In order to compensate for the chromatic aberration introduced by propagation in the waveguide 1, the material of the Mangin mirror 3 is different from the material of the waveguide 1, and, by way of example, it can be N-BK7.

In addition, said optical arrangement includes an inclined multilayer polarization-separator treatment 5 that is positioned on a face inclined by an angle of less than 45° relative to the rear face 1B, ideally by an angle substantially equal to 30°, and that reflects the light beams towards said mirror and transmits the light beams coming from said mirror. It also includes a backing prism 6 on which the multilayer treatment can be deposited.

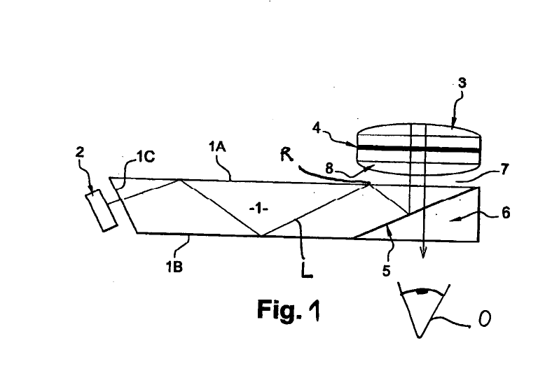

A first variant embodiment is shown in FIG. 1.

In this variant embodiment, the optical arrangement directing the light beams towards the eye O of the wearer through the rear face 1B comprises, superposed on the front face 1A of the waveguide 1 and from the front to the rear:

a plano-convex spherical Mangin mirror 3;

a quarterwave plate 4 that is bonded to the plane face of the mirror;

a lens 8 having a plane face that is bonded to the quarterwave plate; and

a film of air 7.

The layer of air 7 provides the last total internal reflection of the light propagating in the waveguide 1, shown in the figure on the front face by the point R.

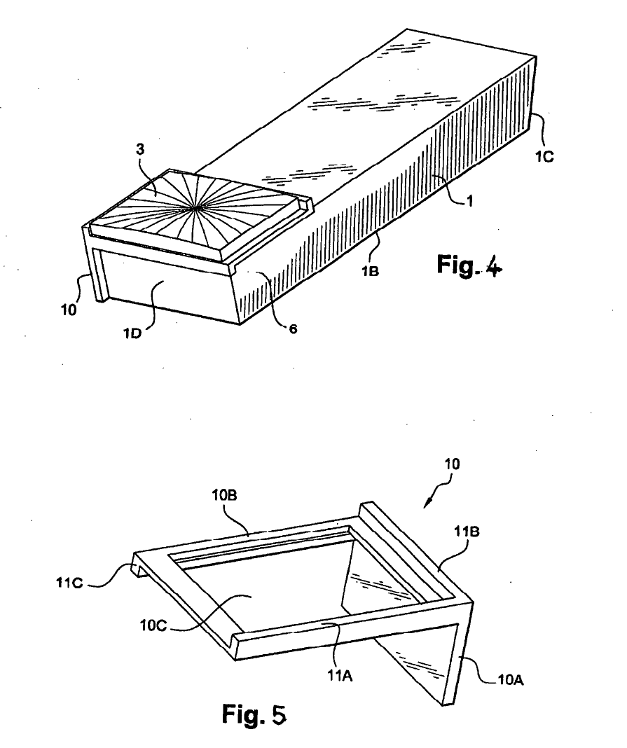

In order to create the layer of air, the Mangin mirror is held by means of a mechanical device that is secured to the front face 1A of the waveguide 1. The mechanical device can be constituted by one or more metal brackets. Such a mechanical support device is shown in FIGS. 4 and 5 described below.

The lens 8 can optionally include an anti-reflection treatment.

The lens 8 can also be of biconvex, biconcave, or meniscus shape. The quarterwave plate can then be constituted by a film or by a deposit of thin-layers.

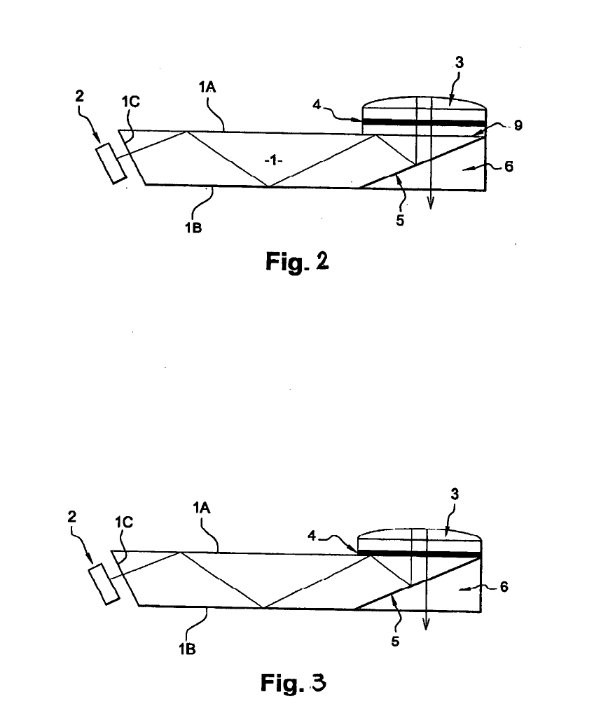

A second variant embodiment is shown in FIGS. 2 and 3.

In the second variant embodiment shown in FIG. 2, the optical arrangement directing the light beams towards the eye O of the wearer through the rear face 1B comprises, superposed on the front face 1A of the waveguide 1 and from the front to the rear:

a plano-convex spherical Mangin mirror 3;

a quarterwave plate 4 that is bonded to the plane face of the mirror; and

a backing plate 9 having a face that is bonded to the quarterwave plate and having another face that is bonded to the front face 1A of the imager and that is provided with an optical isolator treatment.

This variant firstly has the advantage of eliminating the need for a mechanical fastening device, which is tricky and costly to mount and implement. The quarterwave plate is also encapsulated as described above.

The isolator treatment provides reflection of the beams at an inclined incidence, and transmission of the beams close to normal incidence.

In an improvement shown in FIG. 3, instead of using a backing plate 9, it is possible to provide the optical isolator treatment directly on the front face 1A of the waveguide where the quarterwave plate 4 is secured thereto.

This variant has the advantage of providing an imager that is particularly thin.

The operation of an imager of the invention is shown diagrammatically in the figures by the representation of the optical axis L of a light beam coming from the miniature screen 2.

The beam is emitted with an angle of inclination, and is directed so as to be reflected for the first time on the front face 1A of the waveguide. After a plurality of reflections in alternation on the front face 1A and on the rear face 1B of the waveguide, the beam is reflected forwards on the inclined polarization-separator treatment 5, and passes in particular through the quarterwave plate 4 and the Mangin mirror 3. It is reflected on the reflective spherical face of said mirror and is directed towards the eye O of the wearer, passing in particular through the quarterwave plate 4 and the inclined multilayer treatment 5.

FIGS. 4 and 5 show an embodiment of a mechanical support device for supporting the various optical parts on the waveguide 1, specifically shown for the above-described first variant.

The support device 10 supports the Mangin mirror 3, with its quarterwave plate 4 and lens 8 on the front face 1A of the waveguide 1, and it essentially comprises two perpendicular plates. One plate 10A is for coming into abutment against a side face of the waveguide 1, and the other plate 10B comes to bear against the front face 1A. The second plate 10B has an opening and, over said opening 10C, it receives the Mangin mirror 3. The opening 10C thus forms the film of air 7 under the mirror 3.

The second plate 10B includes a plurality of flanges at its edges. Two flanges 11A, 11B are arranged perpendicularly to each other on two edges of its front face. The two flanges are for positioning the Mangin mirror 3 by abutment. Another flange 11C is arranged on an edge of its rear face, and is for positioning the support device 10 by abutment against the end face 1D remote from the inlet face 1C of the waveguide 1.

The support device 10 makes it possible to position the Mangin mirror 3 in relatively accurate manner on the waveguide 1.

1. An optical imager comprising:
a waveguide having a front face and a rear face and into which light beams emitted by an optical element of a light-beam generator system are introduced via an inlet surface and are directed towards the eye of the wearer through said rear face by means of an optical arrangement, so as to make it possible to view information content, said front and rear faces of the waveguide presenting a property of angular selectivity in reflectance and transmittance, wherein said optical arrangement has a Mangin mirror and a quarterwave plate between said front face and said mirror, and wherein said quarterwave plate is encapsulated between said mirror and another element.

2. An imager according to claim 1, wherein said other element is a lens, said optical arrangement including a film of air between said front face and said lens.

3. An imager according to claim 1, wherein said other element is an optical isolator treatment carried by said front face.

4. An imager according to claim 3, wherein said isolator treatment is carried by a backing plate.

5. An imager according to claim 1, wherein said inlet surface is inclined, the first reflection of the light beams taking place on said front face.

6. An imager according to claim 5, wherein said optical element presents an emission surface that is parallel to said inlet surface.

7. An imager according to claim 6, wherein the material of said Mangin mirror is different from the material of said waveguide.

8. An imager according to claim 1, wherein said optical arrangement includes an inclined polarization-separator treatment for reflecting the light beams towards said mirror and for transmitting the light beams coming from said mirror.

9. An imager according to claim 8, wherein said optical arrangement includes a backing prism on which said polarization-separator treatment is deposited.
